(19) United States
(12) Patent Application Publication
(10) Pub. No.: US 2024/0322208 A1
(43) Pub. Date: Sep. 26, 2024

(54) FUEL CELL SYSTEM

(71) Applicants: JTEKT CORPORATION, Kariya-shi (JP); NATIONAL UNIVERSITY CORPORATION KANAZAWA UNIVERSITY, Kanazawa-shi (JP)

(72) Inventors: Takuya TSUJIGUCHI, Kanazawa-shi (JP); Motoo NAKAI, Nara-shi (JP); Toshiyuki SAITO, Kashiba-shi (JP); Atsushi KUBO, Matsubara-shi (JP); Yasuhide TAKEDA, Nisshin-shi (JP); Mototake FURUHASHI, Nagoya-shi (JP); Tatsuma KOUCHI, Kashiwara-shi (JP); Ayumi NAKASONE, Anjo-shi (JP); Atsushi NAKANE, Kariya-shi (JP)

(73) Assignees: JTEKT CORPORATION, Kariya-shi (JP); NATIONAL UNIVERSITY CORPORATION KANAZAWA UNIVERSITY, Kanazawa-shi (JP)

(21) Appl. No.: 18/259,914

(22) PCT Filed: Jan. 7, 2022
(86) PCT No.: PCT/JP2022/000363

§ 371 Date: Jun. 29, 2023

(30) Foreign Application Priority Data
Jan. 20, 2021 (JP) 2021-006854

(51) Int. Cl. H01M 8/04858; H01M 8/04223; H01M 8/04228; H01M 8/04303; H01M 8/04537; H01M 8/04746; H01M 8/04955; H01M 16/00

(52) U.S. Cl. CPC H01M 8/0494; H01M 8/04228; H01M 8/04231; H01M 8/04303; H01M 8/04559; H01M 8/04567; H01M 8/04589; H01M 8/04753; H01M 8/04947; H01M 8/04955; H01M 16/003

(57) ABSTRACT

A fuel cell system includes a fuel cell, an electric power recovery device, and a control device that controls the fuel cell and the electric power recovery device. In a state where supplying of the liquid fuel to the fuel cell is stopped, the control device charges post-stop electric power generated by the fuel cell using the liquid fuel that has been already supplied, thereby recovering the post-stop electric power into the electric power recovery device, and thereafter stopping an electrode reaction in an electrode structure of the fuel cell.

### TECHNICAL FIELD

The present disclosure relates to a fuel cell system.

### BACKGROUND ART

A fuel cell mainly constructed in a fuel cell system, particularly a solid polymer electrolyte fuel cell, generally includes an electrode structure including an anode electrode formed on one surface side of an electrolyte membrane and a cathode electrode formed on the other surface side. In the solid polymer electrolyte fuel cell, fuel is supplied to the anode electrode and an oxidant is supplied to the cathode electrode from the outside, so that an electrode reaction occurs in the electrode structure to generate electric power.

In recent years, a direct type fuel cell has been developed which directly uses a liquid fuel such as methanol or formic acid as a fuel supplied to an anode electrode. When the liquid fuel is used, the liquid fuel is easy to handle, has a high energy density per unit volume, and is extremely useful as compared with a case where a gas such as hydrogen gas is used as a fuel.

In such a direct type fuel cell, a phenomenon may occur in which output electric power due to power generation gradually decreases in a situation where power generation is continuously performed. In order to prevent a decrease in output electric power and maintain the output electric power, a refresh control for periodically stopping the electrode reaction is performed in the direct type fuel cell. When the refresh control is performed, the electrode reaction is temporarily stopped, that is, the power generation is stopped in the direct type fuel cell, so that the output electric power is unstable.

Therefore, in the related art, for example, JP2007-280741A discloses a technique of a fuel cell system including an auxiliary power supply for charging electric power generated by a fuel cell. In the fuel cell system of the related art, the fuel cell outputs electric power to the outside and charges the auxiliary power supply, and the electric power charged (stored) in the auxiliary power supply is discharged in a situation where the output electric power of the fuel cell decreases, so that the electric power output to the outside is stabilized.

In the fuel cell system including a direct type liquid fuel cell, when the refresh control is performed on the fuel cell, supply of liquid fuel to the anode electrode of the fuel cell is normally stopped.

In this case, in the electrode structure, the electrode reaction is stopped after power generation by the electrode reaction using the liquid fuel already supplied is continued.

Therefore, when it takes time for the already supplied liquid fuel to be consumed by the electrode reaction in the electrode structure, time for which the fuel cell stops power generation for outputting electric power to the outside along with the performing of the refresh control becomes long. As a result, even if the electric power charged in the auxiliary power supply is supplied, the electric power output to the outside becomes unstable. Therefore, from a viewpoint of stabilizing the electric power output to the outside, power generation stop time of the fuel cell associated with the refresh control is desirably short.

Normally, along with the refresh control, the electric power that is continuously output from the fuel cell until the liquid fuel already supplied is consumed is wasted by being grounded and discharged. Therefore, from the viewpoint of stabilizing the electric power output to the outside, in addition to performing the refresh control in a short time, it is desirable to recover the electric power wasted by the refresh control and use the recovered electric power in addition to the electric power output from the fuel cell to the outside.

### SUMMARY OF INVENTION

The present disclosure provides a fuel cell system capable of stabilizing electric power output to the outside.

According to an aspect of the present disclosure, a fuel cell system includes: a fuel cell having an electrode structure having an anode electrode and a cathode electrode, and configured to generate electric power by supplying a liquid fuel to the anode electrode and supplying an oxidant to the cathode electrode: an electric power recovery device configured to recover electric power by charging a part of the electric power output from the fuel cell and discharge the charged electric power; and a control device configured to control the fuel cell and the electric power recovery device. In a state where supplying of the liquid fuel to the fuel cell is stopped, the control device is configured to: charge post-stop electric power that the fuel cell generates using the liquid fuel that has been already supplied, thereby recovering the post-stop electric power into the electric power recovery device, and stop an electrode reaction in the electrode structure of the fuel cell after the post-stop electric power is recovered in the electric power recovery device. In a state where the liquid fuel is supplied to the fuel cell, the control device is configured to discharge the recovered post-stop electric power from the electric power recovery device to an external load to supply, to the external load, the recovered post-stop electric power in addition to the electric power output from the fuel cell.

According to this, in the fuel cell system, under the control of the control device, in a state in which the supply of the liquid fuel to the fuel cell is stopped, the electric power recovery device can be charge with and recover the post-stop electric power, and thereafter, the electrode reaction in the fuel cell can be stopped. Under the control of the control device, the fuel cell system can supply the electric power to the external load by discharging the post-stop electric power recovered by the electric power recovery device, in addition to the electric power output from the fuel cell in a state in which the liquid fuel is supplied to the fuel cell.

As a result, the fuel cell system can quickly stop the electrode reaction after the electric power recovery device recovers the post-stop electric power, so that the power generation stop time in accordance with the refresh control can be shortened. In addition, the electric power recovery device can be used by recovering the post-stop electric power that is wasted and discharging the post-stop electric power. Accordingly, the fuel cell system can stabilize the electric power supplied from the fuel cell to the external load.

### BRIEF DESCRIPTION OF DRAWINGS

FIG. 1 is a view showing a configuration of a fuel cell system;

FIG. 2 is a view for describing a configuration of a fuel cell of FIG. 1;

FIG. 3 is a block diagram showing a configuration of a control device of FIG. 1;

FIG. 4 is a view for describing an operation of the fuel cell system in a normal power generation mode;

FIG. 5 is a view for describing an operation of the fuel cell system in a refresh control mode; and

FIG. 6 is a view for describing an operation of the fuel cell system in a capacitor discharge mode.

### DESCRIPTION OF EMBODIMENTS

### 1. Outline of Fuel Cell System 1

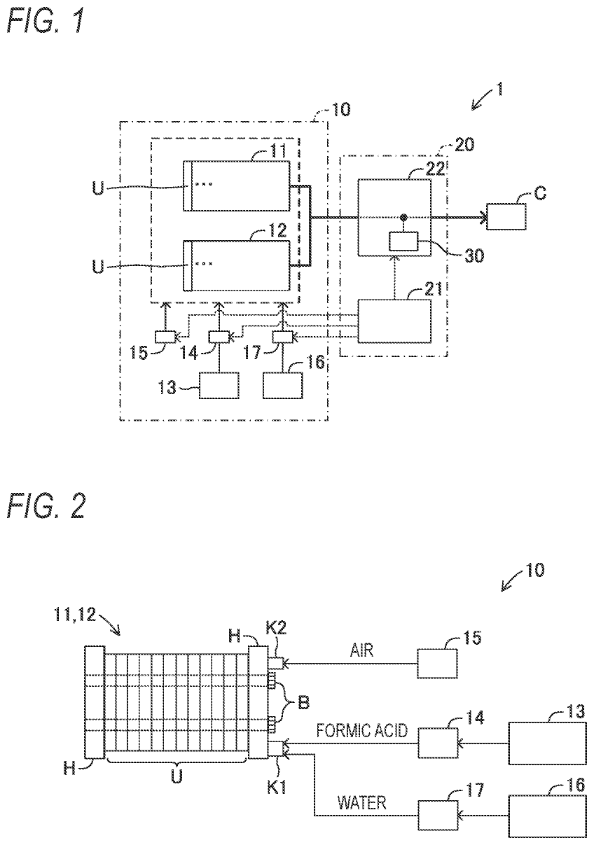

As shown in FIG. 1, a fuel cell system 1 of the present embodiment mainly includes a fuel cell 10, a control device 20, and a capacitor 30 serving as an electric power recovery device. The fuel cell 10 of the present embodiment may be a solid polymer electrolyte fuel cell. In the solid polymer electrolyte fuel cell 10, an anode electrode is formed on one surface side of an electrolyte membrane, and a cathode electrode is formed on the other surface side of the electrolyte membrane. Here, the electrolyte membrane, the anode electrode, and the cathode electrode form a membrane-electrode-assembly (MEA) which is an electrode structure. The anode electrode and the cathode electrode are formed by coating a metal catalyst such as platinum (Pt) or palladium (Pd) and carbon to which the metal catalyst is added. Further, a fuel diffusion layer exists between a catalyst membrane and the electrode.

Examples of the fuel to be supplied to the anode electrode of the solid polymer electrolyte fuel cell 10 include liquid fuels such as formic acid (HCOOH), methanol (CH₃OH), and ethanol (C₂H₅OH). Here, in the fuel cell 10 to be described below, a case where formic acid is directly used as the liquid fuel to be supplied will be exemplified. In other words, a case where the fuel cell 10 is a direct formic acid fuel cell (DFAFC) will be exemplified. Examples of the oxidant (oxidant gas) to be supplied to the cathode electrode of the fuel cell 10 include oxygen (O₂) gas and air. Here, in the fuel cell 10 to be described below, a case where air is used as an oxidant (that is, an oxidant gas) of a gas to be supplied will be exemplified.

In the fuel cell system 1 of the present embodiment, under a control of the control device 20, it is possible to switch among a case where the electric power generated by the fuel cell 10 is supplied to an external load C, a case where the capacitor 30 is charged (stored) with the electric power (including post-stop electric power) generated by the fuel cell 10, and a case where the electric power (including the post-stop electric power) charged (stored) in the capacitor 30 is supplied to the external load C. That is, in the fuel cell system 1 of the present embodiment, a control unit 21 controls a control circuit 22, so that the control device 20 can execute a normal power generation mode in which the electric power generated by the fuel cell 10 is supplied to the load C and a part of the electric power generated by the fuel cell 10 is charged in the capacitor 30.

In the fuel cell system 1 of the present embodiment, the control unit 21 of the control device 20 controls the control circuit 22, so that the capacitor 30 is charged (stored) with the post-stop electric power generated by the fuel cell 10 in accordance with the refresh control. In other words, it is possible to perform a refresh control mode in which the post-stop electric power is recovered and an electrode reaction in the MEA is quickly stopped. Further, in the fuel cell system 1 of the present embodiment, the control unit 21 controls the control circuit 22, so that the control device 20 can execute a capacitor discharge mode in which the post-stop electric power charged (stored) in the capacitor 30 (in other words, the post-stop electric power recovered in the capacitor 30) is discharged (preferably, rapidly discharged) from the capacitor 30 and supplied to the load C. 5

### 2. Configuration of Fuel Cell 10

Hereinafter, a configuration of the solid polymer electrolyte fuel cell 10 of the present embodiment will be described with reference to FIGS. 1 and 2. The fuel cell 10 of the present embodiment is a direct type fuel cell in which formic acid, which is a liquid fuel, is directly supplied to the anode electrode.

As shown in FIG. 1, the fuel cell 10 of the present embodiment includes a first fuel cell stack 11 and a second fuel cell stack 12 that are electrically connected in parallel. The first fuel cell stack 11 and the second fuel cell stack 12 are formed by stacking a plurality of unit cells U each including an MEA (not shown), an anode-side separator (not shown) that supplies a liquid fuel to an anode electrode of the MEA, a cathode-side separator (not shown) that supplies an oxidant (oxidant gas) to a cathode electrode of the MEA, and the fuel diffusion layer (not shown).

As shown in FIG. 2, in the first fuel cell stack 11 and the second fuel cell stack 12, the plurality of unit cells U are stacked, and the stacked unit cells U are held by holders H and bolts B. In each of the first fuel cell stack 11 and the second fuel cell stack 12, a first pump 14 that pressurizes and supplies formic acid, which is a liquid fuel stored in a supply tank 13, is connected to a connection portion K1 via a pipe. In each of the first fuel cell stack 11 and the second fuel cell stack 12, a blower 15 (pressurizing pump) that pressurizes and supplies air as an oxidant (oxidant gas) is connected to a connection portion K2 via a pipe. Here, the first pump 14 and the blower 15 are controlled by the control device 20 (see FIG. 1).

As shown in FIG. 2, in each of the first fuel cell stack 11 and the second fuel cell stack 12, a second pump 17 as a water supply device that pressurizes and supplies water (for example, generated water) stored in the supply tank 16 is connected to the connection portion K1 via a pipe. The second pump 17 is controlled by the control device 20 (see FIG. 1).

Formic acid pressurized by the first pump 14 and water pressurized by the second pump 17 (generated water) are supplied to the anode electrode via a switching valve (not shown). That is, in a case where the first fuel cell stack 11 and the second fuel cell stack 12 generate electric power, the formic acid is supplied to the anode electrode by switching the switching valve, and in a case where the refresh control is performed (that is, in a case where the electrode reaction in the MEA is stopped), the supply of formic acid is stopped. Further, water (generated water) is supplied to the anode electrode by switching the switching valve. The switching valve can be provided in the connection portion K1.

### 3. Details of Configuration of Control Device 20

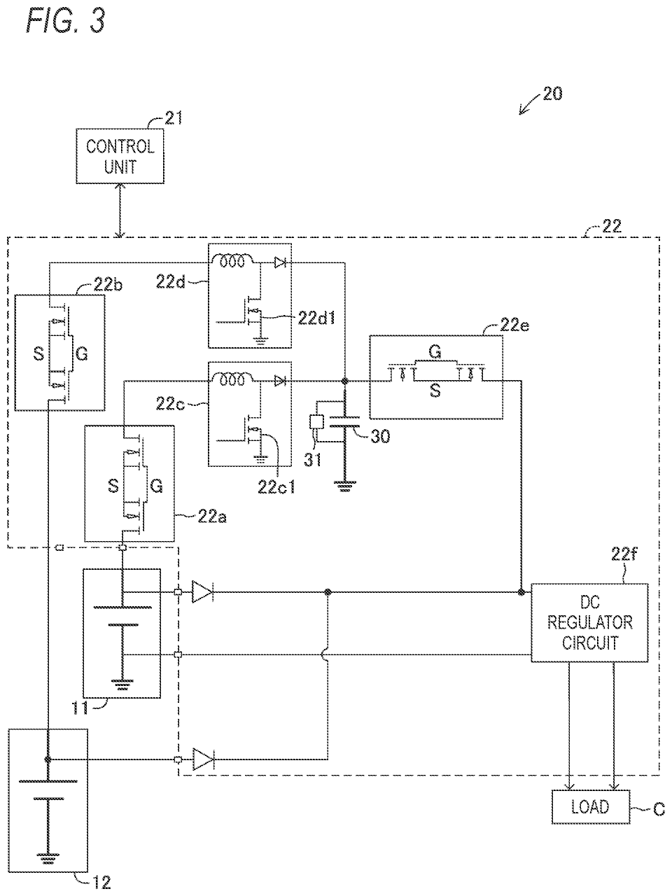

As shown in FIGS. 1 and 3, the control device 20 mainly includes the control unit 21 and the control circuit 22. The control unit 21 is a microcomputer having a CPU, a ROM, a RAM, and an interface as main components.

The control circuit 22 is an electric circuit controlled by the control unit 21. As shown in FIG. 1, the control circuit 22 electrically connects the first fuel cell stack 11 and the second fuel cell stack 12 electrically connected in parallel to the external load C. The control circuit 22 electrically connects the first fuel cell stack 11 and the second fuel cell stack 12 to the capacitor 30, and electrically connects the capacitor 30 to the external load C. Accordingly, under a control of the control unit 21, the control circuit 22 realizes each of a case where the electric power generated by the first fuel cell stack 11 and the second fuel cell stack 12 is supplied to the external load C, a case where the capacitor 30 is charged (stored), and a case where the electric power charged (stored) in the capacitor 30 is supplied to the load C.

As shown in FIG. 3, the control circuit 22 mainly includes a first switch 22a, a second switch 22b, a first boost circuit 22c, a second boost circuit 22d, a capacitor output switch 22e, and a DC regulator circuit 22f. An operation of each of the first switch 22a, the second switch 22b, the first boost circuit 22c, the second boost circuit 22d, the capacitor output switch 22e, and the DC regulator circuit 22f is controlled by the control unit 21.

The first switch 22a is formed of two nMOSFETs (n-channel MOSFET), and is disposed between the first fuel cell stack 11 and the first boost circuit 22c. The first switch 22a is opened and closed by switching the two nMOSFETs to an ON state or an OFF state in synchronization with each other under the control of the control unit 21 to supply or cut off a high voltage electric power output from the first fuel cell stack 11 to the first boost circuit 22c.

In the following description, when the two nMOSFETs are synchronously turned on, it is assumed that the first switch 22a is in the ON state (closed state), and energization from the first fuel cell stack 11 to the first boost circuit 22c is permitted. On the other hand, when the two nMOSFETs are synchronously turned off, it is assumed that the first switch 22a is in the OFF state (open state), and the energization from the first fuel cell stack 11 to the first boost circuit 22c is cut off.

The second switch 22b is formed of two nMOSFETs (n-channel MOSFET), and is disposed between the second fuel cell stack 12 and the second boost circuit 22d. The second switch 22b is opened and closed by switching the two nMOSFETs to the ON state or the OFF state in synchronization with each other under the control of the control unit 21 to supply or cut off a high voltage electric power output from the second fuel cell stack 12 to the second boost circuit 22d.

In the following description, when the two nMOSFETs are synchronously turned on, it is assumed that the second switch 22b is in the ON state (closed state), and energization from the second fuel cell stack 12 to the second boost circuit 22d is permitted. On the other hand, when the two nMOSFETs are synchronously turned off, it is assumed that the second switch 22b is in the OFF state (open state), and the energization from the second fuel cell stack 12 to the second boost circuit 22d is cut off.

The first boost circuit 22c has a well-known configuration, and includes a coil, a diode, and a switch 22cl of an nMOSFET (n-channel MOSFET). The first boost circuit 22c boosts the electric power (voltage) supplied from the first fuel cell stack 11 and supplies the boosted electric power to the capacitor 30 when the switch 22cl is periodically and quickly switched between the ON state and the OFF state under the control of the control unit 21. In the following description, it is assumed that the first boost circuit 22c is in the ON state when the switch 22cl is in the ON state or a switching state (repetition of the ON state and the OFF state). When the switch 22cl is turned off, the first boost circuit 22c is turned off.

The second boost circuit 22d has a well-known configuration, and includes a coil, a diode, and a switch 22dl of an nMOSFET (n-channel MOSFET). The second boost circuit 22d boosts the electric power (voltage) supplied from the second fuel cell stack 12 and supplies the boosted electric power to the capacitor 30 when the switch 22dl is periodically and quickly switched between the ON state and the OFF state under the control of the control unit 21. In the following description, it is assumed that the second boost circuit 22d is in the ON state when the switch 22dl is in the ON state or a switching state (repetition of the ON state and the OFF state). When the switch 22dl is turned off, the second boost circuit 22d is turned off.

The capacitor output switch 22e is formed of two nMOSFETs (n-channel MOSFET), and is disposed between the capacitor 30 and the DC regulator circuit 22f. The capacitor output switch 22e is opened and closed by switching the two nMOSFETs to the ON state or the OFF state in synchronization with each other under the control of the control unit 21 to supply or cut off a high voltage electric power output from the capacitor 30 to the DC regulator circuit 22f.

In the following description, when the two nMOSFETs are synchronously turned on, it is assumed that the capacitor output switch 22e is in the ON state (closed state), and energization from the capacitor 30 to the DC regulator circuit 22f is permitted. On the other hand, when the two nMOSFETs are synchronously turned off, it is assumed that the capacitor output switch 22e is in the OFF state (open state), and the energization from the capacitor 30 to the DC regulator circuit 22f is cut off.

The DC regulator circuit 22f is a so-called well-known switching regulator, and is a circuit that stabilizes electric power (voltage) supplied from the first fuel cell stack 11, the second fuel cell stack 12, and the capacitor 30. In the following description, when a switch (not shown) is turned on, it is assumed that the DC regulator circuit 22f is turned on. When a switch (not shown) is turned off, it is assumed that the DC regulator circuit 22f is turned off.

### 4. Details of Capacitor 30

When the capacitor output switch 22e provided in the control circuit 22 of the control device 20 is in the OFF state (open state), the capacitor 30 as the electric power recovery device is charged (stored) with the high voltage electric power boosted by the first boost circuit 22c and the second boost circuit 22d provided in the control circuit 22 of the control device 20. When the capacitor 30 is charged (stored) to a predetermined voltage, the charged (stored) high voltage electric power is discharged to the DC regulator circuit 22f by controlling the capacitor output switch 22e provided in the control circuit 22 of the control device 20 to be in the ON state (closed state).

As shown in FIG. 3, the capacitor 30 includes a voltage sensor 31 that detects a capacitor voltage Vcap representing the magnitude of charged (stored) electric power (including the post-stop electric power). The voltage sensor 31 outputs the detected capacitor voltage Vcap to the control unit 21.

As will be described later, when the first fuel cell stack 11 and the second fuel cell stack 12 perform normal power generation, the capacitor 30 is charged (stored) with electric power supplied from the first fuel cell stack 11 and the second fuel cell stack 12 according to the capacitor voltage Vcap. In addition, when the first fuel cell stack 11 or the second fuel cell stack 12 discharges electric power in accordance with the refresh control, the capacitor 30 is charged (stored) with at least a part of the electric power discharged as the post-stop electric power. When the voltage of the electric power generated by the first fuel cell stack 11 and the second fuel cell stack 12 electrically connected in parallel decreases, or when the external load C increases, the capacitor 30 supplies the charged (stored) electric power (including the post-stop electric power) by rapid discharge.

In this way, the capacitor 30 can recover electric power by charging (storing) at least a part of the post-stop electric power of the electric power discharged from the first fuel cell stack 11 or the second fuel cell stack 12 under the refresh control. The capacitor 30 can supply the recovered post-stop electric power, in addition to the electric power generated by the first fuel cell stack 11 and the second fuel cell stack 12, to the load C. That is, the capacitor 30 can recover and reuse the electric power.

As the electric power recovery device, for example, a secondary battery such as a storage battery may be used in addition to the capacitor 30. However, since the capacitor 30 generally has a small internal resistance, rapid charge is possible during charging (storing), and rapid discharge is possible during discharging. On the other hand, since the secondary battery such as a storage battery generally has a large internal resistance, it is difficult to perform the rapid charge during charging (power storage) and the rapid discharge during discharging. Therefore, it is preferable to use the capacitor 30 as the electric power recovery device.

### 5. Details of Operation of Fuel Cell System 1

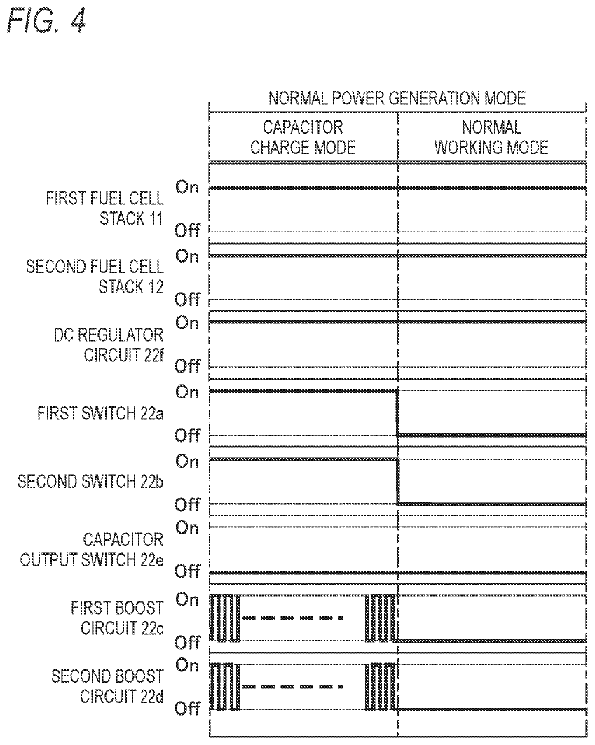

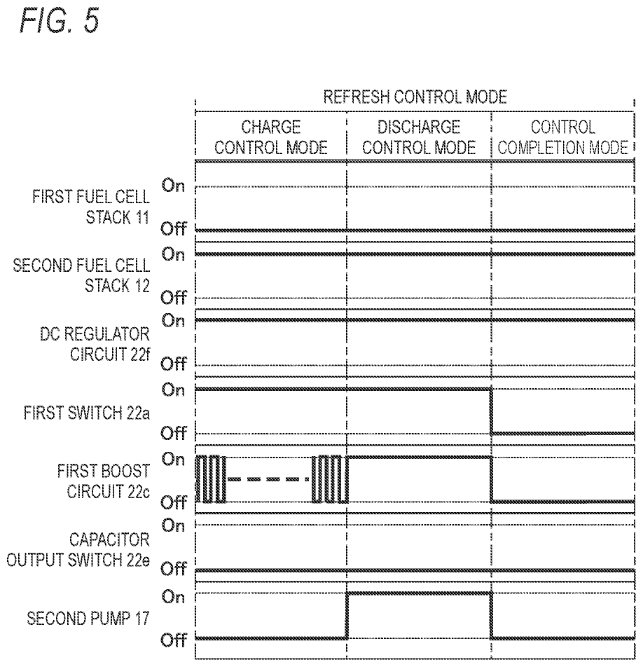

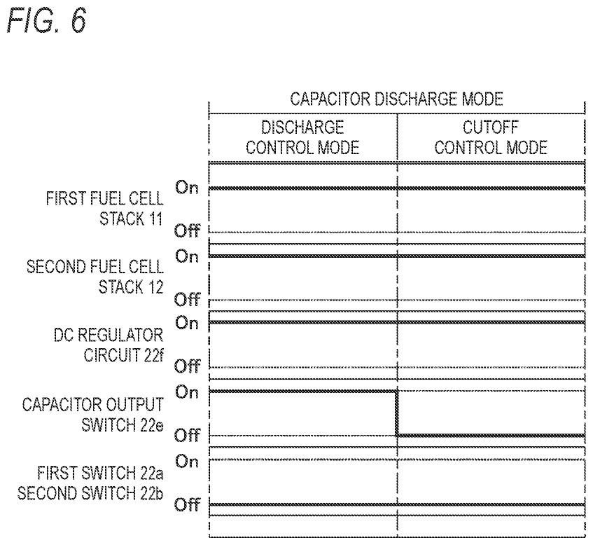

Next, an operation of the fuel cell system 1 of the present embodiment will be described. The fuel cell system 1 of the present embodiment operates in each operation mode of the normal power generation mode shown in FIG. 4, a capacitor charge mode accompanying the stop of power generation shown in FIG. 5, and a capacitor discharge mode shown in FIG. 6, under the control of the control device 20 (control unit 21). Hereinafter, each operation mode will be described in order.

### 5-1. Normal Power Generation Mode

As shown in FIG. 4, the normal power generation mode has two operation modes by switching an operation state of the control circuit 22, which is switched and controlled by the control unit 21 of the control device 20, according to the capacitor voltage Vcap representing a charge voltage of the capacitor 30 detected by the voltage sensor 31. Specifically, the normal power generation mode has the two operation modes: the “capacitor charge mode” in which the capacitor voltage Vcap is lower than the capacitor base voltage Vbase of the capacitor 30; and a “normal working mode” in which the capacitor voltage Vcap is equal to or higher than the capacitor base voltage Vbase.

In the normal power generation mode, as shown in FIG. 4, regardless of a charge state of the capacitor 30, the fuel cell 10 including the first fuel cell stack 11 and the second fuel cell stack 12 which are electrically arranged in parallel is controlled to be in the ON state by the control device 20 to generate electric power. In the normal power generation mode, as shown in FIG. 4, the DC regulator circuit 22f of the control circuit 22 is controlled to be in the ON state, and the electric power generated by the first fuel cell stack 11 and the second fuel cell stack 12 is supplied to the external load C.

### 5-1-1. Capacitor Charge Mode

The capacitor charge mode is an operation mode in which electric power is supplied from at least one of the first fuel cell stack 11 and the second fuel cell stack 12 to the capacitor 30 whose capacitor voltage Vcap is lower than the capacitor base voltage Vbase. In the present embodiment, a case where both the first fuel cell stack 11 and the second fuel cell stack 12 supply the electric power to the capacitor 30 will be exemplified.

In the capacitor charge mode, charging is performed until the capacitor voltage Vcap is equal to or higher than the capacitor base voltage Vbase. As will be described later, an upper limit voltage for charging the capacitor 30 in the capacitor charge state can be set to a capacitor charge preparation voltage Vr that is set to a predetermined voltage value higher than the capacitor base voltage Vbase and that determines whether the capacitor 30 is charged when power generation is stopped.

In the capacitor charge mode, the control unit 21 of the control device 20 switches the first switch 22a and the second switch 22b of the control circuit 22 to the ON state and controls the capacitor output switch 22e of the control circuit 22 to be in the OFF state. Further, the control unit 21 of the control device 20 repeatedly switches the first boost circuit 22c of the control circuit 22 between the ON state and the OFF state to perform a boost switching control. Similarly, the control unit 21 of the control device 20 repeatedly switches the second boost circuit 22d of the control circuit 22 between the ON state and the OFF state to perform the boost switching control.

Accordingly, in the capacitor charge mode, the electric power generated by the first fuel cell stack 11 and the second fuel cell stack 12 is boosted by the first boost circuit 22c and the second boost circuit 22d and is supplied to the capacitor 30. Here, in the capacitor charge mode, since the capacitor output switch 22e is maintained in the OFF state, the supply of the electric power from the capacitor 30 to the DC regulator circuit 22f is cut off. Accordingly, in the capacitor charge mode, the capacitor 30 is charged to the capacitor base voltage Vbase or higher by the electric power boosted and supplied from the first fuel cell stack 11 and the second fuel cell stack 12.

### 5-1-2. Normal Working Mode

The normal working mode is an operation mode in which the capacitor voltage Vcap of the capacitor 30 is equal to or higher than the capacitor base voltage Vbase, and the electric power generated by the first fuel cell stack 11 and the second fuel cell stack 12 is output to the external load C via the DC regulator circuit 22f without charging the capacitor 30.

Therefore, in the normal working mode, the control unit 21 of the control device 20 switches the first switch 22a and the second switch 22b of the control circuit 22 to the OFF state and controls the capacitor output switch 22e of the control circuit 22 to be in the OFF state. The control unit 21 of the control device 20 controls the first boost circuit 22c and the second boost circuit 22d of the control circuit 22 to be in the OFF state.

Accordingly, in the normal working mode, the electric power generated by the first fuel cell stack 11 and the second fuel cell stack 12 is not supplied to the capacitor 30. In the normal working mode, since the capacitor output switch 22e is maintained in the OFF state, the supply of the electric power from the capacitor 30 to the DC regulator circuit 22f is cut off via the capacitor output switch 22e. Accordingly, all the electric power generated by the first fuel cell stack 11 and the second fuel cell stack 12 is output to the external load C via the DC regulator circuit 22f.

### 5-2. Refresh Control Mode

The refresh control mode is an operation mode in which a charge control of the capacitor 30, a discharge control of the fuel cell stack, and a stop control of the fuel cell stack are performed under the control of the control device 20 when one of the first fuel cell stack 11 and the second fuel cell stack 12 in the fuel cell 10 stops power generation in accordance with the refresh control. In the present embodiment, a case where the first fuel cell stack 11 stops power generation by the refresh control and the second fuel cell stack 12 continues power generation in the normal power generation mode (normal working mode) will be exemplified. Here, the fuel cell 10 (in the present embodiment, the first fuel cell stack 11) continues the electrode reaction in the MEA until the liquid fuel that has already been supplied is consumed even after a power generation stop control to be described later has been performed, and therefore outputs the post-stop electric power stop with a voltage drop.

As shown in FIG. 5, the refresh control mode has three operation modes by switching the operation state of the control circuit 22, which is switched and controlled by the control unit 21 of the control device 20. Specifically, the refresh control mode has a charge control mode in which the capacitor 30 is charged with the post-stop electric power output after the power generation stop control of the first fuel cell stack 11 (fuel cell 10), a discharge control mode in which the electric power is discharged from the first fuel cell stack 11 (fuel cell 10) after the stop of the charge control mode, and a control completion mode in which the power generation stop control of the first fuel cell stack 11 (fuel cell 10) is completed.

### 5-2-1. Charge Control Mode

The charge control mode of the present embodiment is executed when the capacitor voltage Vcap of the capacitor 30 is equal to or higher than the capacitor base voltage Vbase and lower than the capacitor charge preparation voltage Vr (Vbase≤Vcap<Vr), and an output voltage Vfc output from the first fuel cell stack 11 is equal to or lower than a preset lower limit output voltage Vlim (Vfc≤Vlim). In the charge control mode, the supply of the liquid fuel to the first fuel cell stack 11 is stopped in response to the first pump 14 being stopped by the control unit 21 of the control device 20, and the charge control mode is switched from the normal working mode. Further, the charge control mode is an operation mode in which, in order for the control unit 21 of the control device 20 to execute the refresh control, after stopping the operation of the first pump 14 to stop the supply of the formic acid to the first fuel cell stack 11 (that is, after performing the power generation stop control), the capacitor 30 is charged with the post-stop electric power output from the first fuel cell stack 11 while the output voltage Vfc decreases.

In the charge control mode, as shown in FIG. 5, the control unit 21 of the control device 20 switches the first switch 22a of the control circuit 22 to the ON state and controls the capacitor output switch 22e of the control circuit 22 to be in the OFF state. Further, the control unit 21 of the control device 20 repeatedly switches the first boost circuit 22c of the control circuit 22 between the ON state and the OFF state to perform a boost switching control. The second switch 22b and the second boost circuit 22d of the control circuit 22 electrically connected to the second fuel cell stack 12 are controlled to be in the OFF state by the control unit 21.

Accordingly, in the charge control mode, the post-stop electric power generated by the first fuel cell stack 11 after the power generation stop control in which the supply of the liquid fuel (formic acid) by the first pump 14 is stopped is boosted by the first boost circuit 22c and supplied to the capacitor 30. Accordingly, in the charge control mode, the capacitor 30 is charged until the capacitor voltage Vcap is a full charge voltage Vm. In the charge control mode, since the capacitor output switch 22e is maintained in the OFF state, the supply of the electric power from the capacitor 30 to the DC regulator circuit 22f is cut off.

Here, at least a part of the post-stop electric power generated after the power generation stop control of the first fuel cell stack 11 is performed (that is, after the supply of the liquid fuel (formic acid) is cut off) is charged and stored in the capacitor 30. As will be described later, the electric power including the post-stop electric power charged (stored) in the capacitor 30 is supplied to the outside via the DC regulator circuit 22f when necessary. Accordingly, by executing the charge control mode, at least a part of the post-stop electric power generated by the first fuel cell stack 11 after the power generation stop control is recovered by the capacitor 30 and effectively used. As a result, utilization efficiency of electric energy can be improved as compared with the case where the post-stop electric power is wasted in the normal refresh control, and thus energy saving can be realized.

### 5-2-2. Discharge Control Mode

The discharge control mode of the present embodiment is switched from the charge control mode when the capacitor voltage Vcap of the capacitor 30 is equal to or higher than the full charge voltage Vm (Vcap≥Vm), the capacitor 30 is fully charged, or when the output voltage Vfc of the first fuel cell stack 11 becomes equal to or lower than a minimum voltage Vmin (Vfc≤Vmin) that enables charging (or boosting). Further, the discharge control mode is an operation mode in which the first fuel cell stack 11 is forcibly discharged preferentially in order to quickly stop the electrode reaction in the MEA. The discharge control mode is an operation mode in which water is supplied to the anode electrode of the first fuel cell stack 11 in order to forcibly discharge the formic acid remaining in the anode electrode in addition to the forced discharge of the first fuel cell stack 11.

In the discharge control mode, as shown in FIG. 5, the control unit 21 of the control device 20 maintains the first switch 22a of the control circuit 22 in the ON state and switches the switch 22cl of the first boost circuit 22c of the control circuit 22 to the ON state. Accordingly, the first fuel cell stack 11 is forcibly discharged by forcibly short-circuiting the anode electrode of the first fuel cell stack 11. In the discharge control mode, the capacitor output switch 22e of the control circuit 22 is maintained in the OFF state.

The control device 20 operates the second pump 17, for example, supplies the generated water to the anode electrode, and discharges the formic acid remaining in the anode electrode. As a result, in the discharge control mode, since water is supplied to the anode electrode, the electrode reaction in the MEA is forcibly and quickly stopped. That is, by executing the discharge control mode, it is possible to quickly shift to the control completion mode to be described later, and as a result, it is possible to quickly complete the refresh control.

### 5-2-3. Control Completion Mode

The control completion mode of the present embodiment is switched from the discharge control mode when an output current Ifc output from the first fuel cell stack 11 subjected to the power generation stop control is equal to or lower than a preset lower limit current Ilow (Ifc≤Ilow). In this case, actually, the switching process is executed based on the output voltage Vfc correlated with the output current Ifc and a voltage value correlated with the lower limit current Ilow. Further, the control completion mode is an operation mode in which the refresh control is completed after a certain period of time has elapsed.

In the control completion mode, as shown in FIG. 5, the control unit 21 of the control device 20 switches the first switch 22a maintained in the ON state in the charge control mode and the discharge control mode to the OFF state. Further, in the control completion mode, the control unit 21 of the control device 20 switches the switch 22cl of the first boost circuit 22c of the control circuit 22 switched to the ON state in the discharge control mode to the OFF state. Further, in the control completion mode, the control unit 21 of the control device 20 stops the operation of the second pump 17 in order to stop the water supplied to the anode electrode in the discharge control mode. As a result, the refresh control for the first fuel cell stack 11 of the fuel cell 10 is completed.

The refresh control for the second fuel cell stack 12 is performed in the same manner as the refresh control for the first fuel cell stack 11 described above. That is, in the charge control mode, the control unit 21 of the control device 20 switches the second switch 22b of the control circuit 22 to the ON state and controls the capacitor output switch 22e of the control circuit 22 to be in the OFF state. Further, the control unit 21 of the control device 20 repeatedly switches the second boost circuit 22d of the control circuit 22 between the ON state and the OFF state to perform the boost switching control.

In the discharge control mode, the control unit 21 of the control device 20 maintains the second switch 22b of the control circuit 22 in the ON state and switches the switch 22dl of the second boost circuit 22d of the control circuit 22 to the ON state. Accordingly, the second fuel cell stack 12 is forcibly discharged by forcibly short-circuiting the anode electrode of the second fuel cell stack 12. In addition, the control unit 21 of the control device 20 operates the second pump 17 to supply the generated water to the anode electrode of the second fuel cell stack 12 and discharge the formic acid remaining in the anode electrode. As a result, in the second fuel cell stack 12, since water is supplied to the anode electrode, the electrode reaction in the MEA is forcibly and quickly stopped.

In the control completion mode, the control unit 21 of the control device 20 switches the second switch 22b maintained in the ON state in the charge control mode and the discharge control mode to the OFF state. The control unit 21 of the control device 20 switches the switch 22dl of the second boost circuit 22d of the control circuit 22 switched to the ON state in the discharge control mode to the OFF state. Further, the control unit 21 of the control device 20 stops the operation of the second pump 17. As a result, the refresh control for the second fuel cell stack 12 is completed. Then, the control unit 21 of the control device 20 operates the first pump 14 to restart the supply of the formic acid to the first fuel cell stack 11, and operates the fuel cell 10 including the first fuel cell stack 11 in the normal power generation mode.

### 5-3. Capacitor Discharge Mode

The capacitor discharge mode is an operation mode in which, in a state where the first fuel cell stack 11 and the second fuel cell stack 12 generate electric power in the normal power generation mode (normal working mode) and supply the electric power to the external load C via the DC regulator circuit 22f, the electric power including the post-stop electric power charged (stored) in the capacitor 30 is supplied to the external load C via the DC regulator circuit 22f. As will be described later, the capacitor discharge mode is an operation mode that is performed in a situation where the electric power generated by the first fuel cell stack 11 and the second fuel cell stack 12 electrically connected in parallel decreases, or in a situation where the external load C is changed so as to increase.

As shown in FIG. 6, the capacitor discharge mode has two operation modes by switching the operation state of the control circuit 22, which is switched and controlled by the control unit 21 of the control device 20. Specifically, the capacitor discharge mode has a discharge control mode in which the electric power including the post-stop electric power charged (stored) from the capacitor 30 is supplied to the outside and a cutoff control mode in which the supply of the electric power from the capacitor 30 is cut off.

### 5-3-1. Discharge Control Mode

The discharge control mode in the capacitor discharge mode is an operation mode in which, when the output voltage Vfc of one of the first fuel cell stack 11 and the second fuel cell stack 12 in the fuel cell 10 generating electric power in the normal working mode is lower than a required output voltage Vd (Vfc<Vd), or when a maximum output current Imax supplied to the external load C via the DC regulator circuit 22f is lower than a required current Id required for the load C (Imax<Id), the electric power including the post-stop electric power is supplied from the capacitor 30. Here, the required output voltage Vd is set to, for example, a value lower than the capacitor base voltage Vbase of the capacitor 30. In the discharge control mode, the fuel cell 10 including the first fuel cell stack 11 and the second fuel cell stack 12 continues the power generation.

In the discharge control mode, as shown in FIG. 6, the control unit 21 of the control device 20 switches the capacitor output switch 22e from the OFF state to the ON state while maintaining the DC regulator circuit 22f in the ON state. The control unit 21 of the control device 20 maintains the first switch 22a and the second switch 22b in the OFF state.

Accordingly, in the discharge control mode of the capacitor discharge mode, the capacitor 30 is electrically connected to the DC regulator circuit 22f via the capacitor output switch 22e. At this point, the capacitor 30 is charged (stored) with electric power including the post-stop electric power at least up to the capacitor base voltage Vbase or higher (for example, the full charge voltage Vm) by the above-described capacitor charge mode or charge control mode. That is, when the discharge control mode is performed, the capacitor voltage Vcap of the capacitor 30 is higher than the output voltage Vfc of the first fuel cell stack 11 or the second fuel cell stack 12.

Therefore, in addition to the electric power generated by the first fuel cell stack 11 and the second fuel cell stack 12, the capacitor 30 can supply the charged (stored) electric power (including the post-stop electric power) to the external load C via the DC regulator circuit 22f by discharging the charged (stored) electric power. In addition, when the capacitor 30 supplies the electric power (including the post-stop electric power) by discharging, the maximum output current Imax supplied to the external load C via the DC regulator circuit 22f can be increased, and as a result, the external load C can stably receive the supply of the required current Id.

### 5-3-2. Cutoff Control Mode

The cutoff control mode is an operation mode in which the supply of the electric power from the capacitor 30 to the DC regulator circuit 22f is cut off when the capacitor voltage Vcap of the capacitor 30 is equal to or lower than the output voltage Vfc of the first fuel cell stack 11 or the second fuel cell stack 12 (Vcap≤Vfc) due to discharging. In the cutoff control mode, as shown in FIG. 6, the control unit 21 of the control device 20 switches the capacitor output switch 22e switched to the ON state in the discharge control mode to the OFF state.

As a result, the electrical connection between the capacitor 30 and the DC regulator circuit 22f is cut off. Accordingly, the supply of the electric power from the capacitor 30 (that is, discharge of the capacitor 30) is cut off.

As can be understood from the above description, according to the fuel cell system 1, the capacitor 30, which is the electric power recovery device, can be charged with and recover the post-stop electric power by executing the charge control mode after the supply of formic acid, which is the liquid fuel to the first fuel cell stack 11 or the second fuel cell stack 12 of the fuel cell 10, is stopped in accordance with the execution of the refresh control mode. The fuel cell system 1 can supply the electric power to the external load by discharging the post-stop electric power recovered by the capacitor 30 by the execution of the discharge control mode, in addition to the electric power output from the first fuel cell stack 11 and the second fuel cell stack 12 of the fuel cell 10 in accordance with the execution of the capacitor discharge mode.

Accordingly, the fuel cell system 1 can use the electric power recovery device by the electric power recovery device recovering the post-stop electric power that is wasted and discharging the post-stop electric power. Therefore, the fuel cell system 1 can stabilize the electric power supplied from the first fuel cell stack 11 and the second fuel cell stack 12 of the fuel cell 10 to the external load C.

In the fuel cell system 1, in the discharge control mode of the refresh control mode, the first fuel cell stack 11, which is one of the first fuel cell stack 11 and the second fuel cell stack 12, which has been subjected to the power generation stop control by the refresh control (that is, the supply of formic acid is stopped), preferentially performs short-circuit discharge of the cathode electrode to the anode electrode. Further, the fuel cell system 1 supplies water to the anode electrode of the first fuel cell stack 11 and discharges the remaining formic acid. As a result, the first fuel cell stack 11 can quickly discharges the electric power due to a short circuit, and stop the electrode reaction in the MEA to stop the power generation. That is, the fuel cell system 1 can quickly complete the refresh control, and can quickly shift to the normal power generation mode after the execution of the control completion mode.

Accordingly, the fuel cell system 1 can shorten power generation stop time in which the fuel cell 10 (the first fuel cell stack 11, which is one of the first fuel cell stack 11 and the second fuel cell stack 12) stops the power generation in accordance with the refresh control. As a result, the electric power supplied from the fuel cell 10 (the first fuel cell stack 11 and the second fuel cell stack 12) to the external load C can be prevented from becoming unstable, and the electric power output to the external load C can be stabilized.

In the fuel cell system 1, the capacitor 30 can recover the post-stop electric power output from the fuel cell 10 (the first fuel cell stack 11 and the second fuel cell stack 12), which has been wasted by discharging, by charging (storing) the electric power, and then output (supply) the post-stop electric power to the external load C by discharging the electric power. Therefore, the utilization efficiency of the electric power generated by the fuel cell 10 can be improved, and as a result, energy saving can be realized.

In the present embodiment described above, the case where the fuel cell system 1 includes two fuel cell stacks, that is, the first fuel cell stack 11 and the second fuel cell stack 12 has been described. However, in the fuel cell system 1, the number of fuel cell stacks is not limited to two, and three or more fuel cell stacks may be provided. Even when the number of the fuel cell stacks is three or more, the same effects as those of the present embodiment described above can be obtained.

The present application is based on Japanese Patent Application No. 2021-006854 filed on Jan. 20, 2021, the contents of which are incorporated herein by reference.

1. A fuel cell system comprising:
a fuel cell having an electrode structure having an anode electrode and a cathode electrode, and configured to generate electric power by supplying a liquid fuel to the anode electrode and supplying an oxidant to the cathode electrode;
an electric power recovery device configured to recover electric power by charging a part of the electric power output from the fuel cell and discharge the charged electric power; and
a control device configured to control the fuel cell and the electric power recovery device, wherein
in a state where supplying of the liquid fuel to the fuel cell is stopped, the control device is configured to:
charge post-stop electric power that the fuel cell generates using the liquid fuel that has been already supplied, thereby recovering the post-stop electric power into the electric power recovery device, and
stop an electrode reaction in the electrode structure of the fuel cell after the post-stop electric power is recovered in the electric power recovery device, and
in a state where the liquid fuel is supplied to the fuel cell, the control device is configured to:
discharge the recovered post-stop electric power from the electric power recovery device to an external load to supply, to the external load, the recovered post-stop electric power in addition to the electric power output from the fuel cell.

2. The fuel cell system according to claim 1, wherein
the control device is configured to short-circuit the fuel cell when an output voltage of the post-stop electric power is equal to or lower than a minimum voltage chargeable to the electric power recovery device.

3. The fuel cell system according to claim 1, further comprising:
a water supply device configured to supply water to the anode electrode of the fuel cell, wherein
the control device is configured to supply the water from the water supply device to the anode electrode, when a charge voltage representing a charge state of the electric power recovery device reaches a full charge voltage representing full charge of the electric power recovery device, or when the output voltage of the post-stop electric power is equal to or lower than the minimum voltage chargeable to the electric power recovery device.

4. The fuel cell system according to claim 1, wherein
the control device is configured to resume supplying the liquid fuel to the fuel cell, when a current output from the fuel cell is equal to or lower than a predetermined minimum output current.

5. The fuel cell system according to claim 1, wherein
the electric power recovery device is configured to charge the post-stop electric power, when the charge voltage representing the charge state is equal to or lower than a charge preparation voltage set to voltage lower than the full charge voltage in a full charge state.

6. The fuel cell system according to claim 1, wherein
the electric power recovery device is configured to charge the post-stop electric power that is boosted higher than an output voltage of the fuel cell.

7. The fuel cell system according to claim 1, wherein
the electric power recovery device is configured to discharge the post-stop electric power, thereby supplying the post-stop electric power to the load, when the output voltage of the fuel cell is equal to or lower than a predetermined required output voltage, or when the current output from the fuel cell is equal to or lower than a required output current of the load.

8. The fuel cell system according to claim 7, wherein
the control device is configured to stop discharging the post-stop electric power to the load, when the charge voltage representing the charge state of the electric power recovery device is equal to or lower than the output voltage of the fuel cell.

9. The fuel cell system according to claim 1, wherein
the electric power recovery device includes a capacitor.

10. The fuel cell system according to claim 1, wherein
in a state where the liquid fuel is supplied to the fuel cell by the control device, the electric power recovery device is configured to charge the electric power output from the fuel cell, when the charge voltage representing the charge state of the electric power recovery device is lower than a predetermined basic voltage.

11. The fuel cell system according to claim 1, wherein
the fuel cell includes a plurality of fuel cell stacks electrically connected in parallel.

12. The fuel cell system according to claim 1, wherein
the liquid fuel is formic acid (HCOOH).
